(19) United States
(12) Patent Application Publication
(10) Pub. No.: US 2022/0358588 A1
(43) Pub. Date: Nov. 10, 2022

(54) SYSTEMS AND METHODS FOR ESG CAPITAL DERIVATIVES, SWAPS, OPTIONS, AND SWAPTIONS

(71) Applicant: Talal A. DEBS, West Harrison, NY (US)

(72) Inventor: Talal A. DEBS, West Harrison, NY (US)

(21) Appl. No.: 17/737,804

(22) Filed: May 5, 2022

Related U.S. Application Data
(60) Provisional application No. 63/184,713, filed on May 5, 2021.

(51) Int. Cl. G06Q 40/04

(52) U.S. Cl. CPC G06Q 40/04

(57) ABSTRACT

A method for sustainability technology swaps allows a sustainable technology provider to partner with a stranded asset owner. The stranded asset owner provides stranded asset access to the sustainable technology partner. The sustainable technology partner improves the stranded assets in order to meet a sustainability target. Upon meeting the sustainability target, the stranded asset owner conveys a pro-rata interest in the stranded assets to the sustainable technology partner.

### CROSS-REFERENCE TO RELATED APPLICATIONS

This application claims the benefit of U.S. Provisional Patent Application No. 63/184,713, filed May 5, 2021, the contents of which are incorporated herein by reference in its entirety.

### BACKGROUND

The current market for capital is facing new, and some say unprecedented, challenges relating to “disruptive technologies,” such as those related to autonomous robotics, genomic advancement, next generation communication system, and others. As a result, many predict so-called “stranded assets” in the form of older industrial installations which are suddenly no longer economic in terms of their future return prospects but will likely remain an integral part of the functioning world economy for some time.

For example, an oil and gas producing energy asset which must continue to obtain capital to provide needed energy is confronted with the fact that capital providers (e.g., banks and equity capital providers) do not have the appetite or ability to deploy new capital to these legacy technologies. The stranded asset in this case would become a sustainability burden on the economy for years to come through: (a) loss of employment; and (b) a concomitant negative impact on local communities, vendors, downstream counterparties, etc. In addition, the asset would represent increased environmental risk due to the unavailability of funds for proper functioning and implementation of otherwise available technology upgrades.

In the past, those attempting to address the so called “stranded asset” problem have looked to various means of socializing associated costs. Either by the imposition of: (i) increased levies on the public via regulatory fiat; or (ii) a broader taxation burden. Other stranded asset problems which illustrate this in recent history include the unregulated power generation stranded asset bottleneck created in the early 90s by laws such as the “6 cent” ruling relating to Qualifying Facilities under the Public Utility Reform Policy Act of 1978 (PURPA) in the State of New York. In that case, as a result of increased costs, ratepayers, pension bondholders and the public at large faced what can be argued are regressive penalties when they had little or nothing to do with the creation of the stranded asset problem. On top of this, even with cost sharing apportioned, the transition away from stranded assets was not able to benefit from the efficiencies generated by a fair and well-regulated profit motive. Consequently, costs were likely larger than they would have otherwise been. All of these possible pitfalls face the emerging stranded asset problem that presently confronts the US economy. It is notable that, in addition to oil and gas, the recent disaster in Texas (i.e., the winter storm of February 2021) will likely result in over 100 Bn in stranded assets.

### SUMMARY

According to some embodiments, A method for a sustainable technology swap includes providing, to a sustainable technology provider, an option to acquire a real property interest in a stranded asset; setting a sustainability target, the sustainability target associated with operation of the stranded asset; meeting, by the sustainable technology provider, the sustainability target; and conveying, to the sustainability technology provider, and based at least in part on the sustainability technology partner meeting the sustainability target, an interest in the stranded asset. Of course, the conveyed interest may not be directly tied to the asset, but could similarly be an interest in a business structure, another asset, a group of assets, or some other interest.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1 is an example method for a sustainable technology swap, in accordance with some embodiments.

### DETAILED DESCRIPTION

Sustainable Technology Swaps (“STS”) represent a novel business process in that the contract will provide a new solution to a significant new problem posed by the various ways in which the economies of the most developed countries in particular are being disrupted. This disruption is primarily being caused by: (1) new technologies; and (2) new Environmental, Social, and Governance (ESG) related goals, whether imposed by free market pressures, new regulations or a combination of the two. STS contracts facilitate the flow of capital to support the disrupted technologies while achieving these goals. A swap option, or swaption, allows a party to enter into a contract to swap interest rate, or some other type of swap, in exchange for an options premium. The buyer gains the right, but not the obligation, to enter into a specified swap contract with the issuer on some future date.

Swaptions are typically either a payer swaption or a receiver swaption. A payer swaption, the purchaser has the right to enter into a swap contract where they become the fixed-rate payer and the floating-rate receiver. A receiver swaption, on the other hand, allows the purchaser (at the purchaser's option) to enter into a swap contract where they will receive the fixed rate and pay the floating rate.

Swaptions may be used to hedge option positions on bonds, to aid in restructuring current positions, to alter a portfolio, or as described herein, to swap sustainability targets for access to reference assets, such as a real property interest in the reference assets.

As one non-limiting example, a swaption may be based on a sustainable technology swap (hereinafter, “STS”). An STS contract represents a superior and novel solution to the stranded asset problem. Specifically, according to some embodiments, through the incentivization of new capital, owners of stranded assets can apply the very best emerging technologies to mitigate issues that arise. STS contracts achieve the foregoing in the following manner:

In some cases, a first party may be a Sustainability Technology Provider (“STP”). The first party may purchase, or otherwise have a right to exercise, the option to achieve (via application of its technology) stipulated Sustainability Targets (“ST”), which in many cases may be at its own expense. As an example, an STP may be able to meet a Sustainability Target, which may be, for example, a measured emissions reduction, and therefore subsequently have the right to obtain an interest in a physical asset as a result of meeting the sustainability target.

A second party may be a Stranded Asset Owner (“SAO”) and allows the first party STP access to the Reference Assets (“RA”) of the Stranded Asset Owner in order to achieve the Sustainability Targets. The second party may grant the first party STP the option to acquire a real property interest in the pro-rata share of the RA upon achieving defined Sustainability Targets.

As an example of the above scenario, in the case of a methane reduction contract for the creation of zero carbon intensity hydrocarbons, an STS contract may be implemented as follows between the first party STP and the second party SAO.

The first party STP acquires an option to meet ST, which may be a reduction of methane emissions (vented or flared) measured in equivalent metric tons of atmospheric carbon emissions. The acquired option may include a proportion of the SAO's hydrocarbon production which represents the quantum of ST achieved at a conversion factor of 0.5 metric tons of CO2 equivalent reduction per barrel of oil produced. In some examples, the proportion conveyed may be in the form of a real property interest in hydrocarbon leases (excluding or including royalty-based leverage, which may be determined on a case-by-case basis). Such real property interest is likely to activate a Net Profits Interest (“NPI”).

A valid consideration on exercise of the STP option may be quantified at Fair Value or Tax Book Value depending on the goals of: (x) the SAO and the STP; and (y) the relevant third-party negotiation. In some cases, settlement of the exercised option for meeting the stipulation targets may be in cash, equity in STP, options in equity of STP, a combination of the foregoing, or some other remuneration.

The proposed solution leverages a new emerging risk factor known as dynamical risk. Investors, and their advisors and intermediaries, have traditionally decomposed risk factors in many different helpful (and sometimes not so helpful) categories. Within traditional corporate finance, so called “risk stripes” include well known categories like market risk and credit risk. However, recent attempts to make a serious effort at quantifying risk that does not fall into traditional categories has resulted in creating risk buckets that may include operational risk, or even worse and no more descriptive, non-financial risk. These risks include all the hard to quantify sources (cyber, legal, reputational, environmental, etc.) of potential gain or loss (too often framed only with respect to loss) that can affect an investor.

Of course, these may not be totally non-financial risks, and they can lead to material financial impacts. One important key to understanding risk is capital. The largest banks have recognized the impact of operational risk. For instance, J.P. Morgan reported (as of Dec. 31, 2019) risk weighted assets (RWA) for operational risk as 28% of the total, leaving the obvious category for a bank—credit risk—with only 66% and dwarfing market risk with more than five times the RWA allocation.

In fact, some have posited that these trends apply outside the rarefied world of the Basel III Advanced Approach to Bank Capital. Many of the well-known “factor investing” pioneers have recently realized the importance of this operation risk awareness. Many leaders in private equity and alternative data have all begun to realize the significance of understanding the operational risks and rewards that were previously buried within portfolios.

It is clear there are now whole new realms of risk and opportunity for an investor to understand, especially with the realization and acceptance of “non-financial risks.” One of these non-financial risk factors that shows a very interesting juxtaposition with more traditional risk factors is a genus of related risk factors, known as dynamical risk.

Dynamics is the aspect of physical science which describes how systems change over time. The dynamics of a physical system refer to its foundational causal features. These features usually drive a variable set of outcomes. On the micro-scale, this may often be described by quantum mechanical means. For the investor, however, dynamics is the world of predicting physical outcomes based on empirically developed mathematical models.

Dynamical risks, therefore, are those risks to an investment thesis that are driven by the physics of underlying real assets. As an example, the complicated geophysical properties of oil and gas wells provide real world physics of underlying assets that can be studied and evaluated for dynamical risk within an investment. Equally salient are the physics of wind and solar power generation, storage, and transport.

With the availability of vast troves of alternative data, and the computing power to handle it, dynamical risk is not a purely academic concept. In fact, dynamical risk has always been there, but now it can be quantified in helpful ways. In some cases, investors are in a race to take advantage of the opportunity these developments present, using both old and new techniques, such as artificial intelligence and deep learning.

According to some embodiments, many of the previously significant investment factors can be further decomposed into dynamical risk. In recent years, some have despaired that the golden age of creativity in finance is over. However, understanding dynamical risk has the potential to breathe new life into the way investors think about their portfolios and achieve their goals.

According to some embodiments, understanding dynamical risk allows one to understand the physics of physical systems in order to make informed decision, such as investment decisions, by also leveraging the powers of machine learning and artificial intelligence on these complex physical systems.

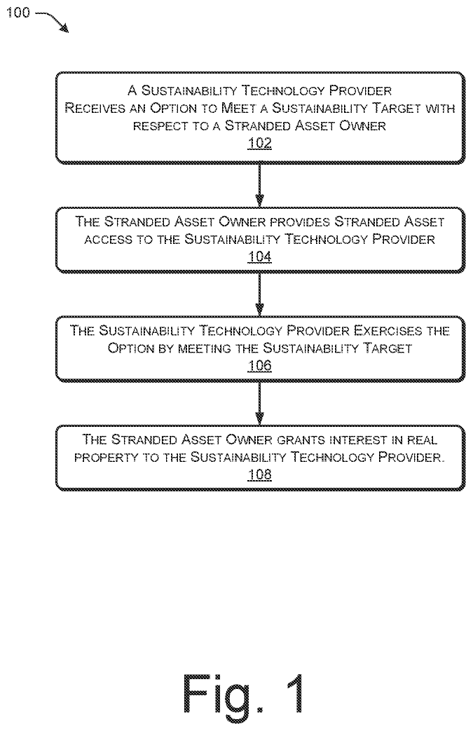

With reference to FIG. 1, a method 100 for providing ESG capital derivatives, swaps, options, and swaptions is illustrated. At block 102, an STP receives an option to meet a sustainability target with respect to a stranded asset owner. The option may be received in exchange for meeting a sustainability target. The option may include any form of remuneration, including a pro-rata share of an asset.

At block 104, the stranded asset owner provides stranded asset access to the sustainability technology provider. This allows the sustainability technology provider to work with the stranded asset in order to improve a characteristic of the asset. Improving the characteristic may include improving the operation, function, quality, quantity, condition, efficiency, or some other characteristic of the asset. Improving the characteristic may include any suitable improvement, but in some cases, improving the characteristic includes making capital improvements and/or improving the operation of the asset.

At block 106, the sustainability technology provider exercises the option by meeting the sustainability target. As described herein, the sustainability target may be any suitable target that the SAO and STP agree upon and may include improving one or more characteristics of the asset.

At block 108, the stranded asset owner grants an interest in real property to the sustainability technology provider. Granting the interest may be in exchange for meeting the sustainability target.

In some cases, the disclosed method functions similar to a derivative contract that may be traded on a regulated exchange. However, the described embodiments are more applicable to infuse capital into stranded assets with an expectation that the stranded assets will see an upward trend over time by virtue of meeting the sustainability targets.

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of” Finally, for ease of use, the terms “including” and “having” (and their derivatives), as used in the

The specification and annexed drawings disclose examples of systems, apparatus, devices, and techniques that may provide control and optimization of separation equipment. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

Those skilled in the art will appreciate that, in some implementations, the functionality provided by the processes and systems discussed above may be provided in alternative ways, such as being split among more software programs or routines or consolidated into fewer programs or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed and various elements may be added, reordered, combined, omitted, modified, etc., in other implementations.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A method for a sustainable technology swap, comprising:
providing, to a sustainable technology provider, an option to acquire a real property interest in a stranded asset;
setting a sustainability target, the sustainability target associated with operation of the stranded asset;
meeting, by the sustainable technology provider, the sustainability target; and
conveying, to the sustainability technology provider, and based at least in part on the sustainability technology provider meeting the sustainability target, an interest in the stranded asset.
